(19) United States
(12) Patent Application Publication
(10) Pub. No.: US 2021/0064065 A1
(43) Pub. Date: Mar. 4, 2021

(54) METHODS, DEVICES, MOBILE ROBOTS, AND SYSTEMS OF NAVIGATION PATH TRACKING CONTROL

(71) Applicant: SZ DJI TECHNOLOGY CO., LTD., Shenzhen (CN)

(72) Inventors: Fucai CHEN, Shenzhen (CN); Jiang YAN, Shenzhen (CN)

(73) Assignee: SZ DJI TECHNOLOGY CO., LTD., Shenzhen (CN)

(21) Appl. No.: 17/096,782

(22) Filed: Nov. 12, 2020

Related U.S. Application Data
(63) Continuation of application No. PCT/CN2018/092592, filed on Jun. 25, 2018.

(51) Int. Cl. G05D 1/10; B64C 39/02

(52) U.S. Cl. CPC G05D 1/106; B64C 2201/141; B64C 39/024

(57) ABSTRACT

The present application provides a device, a mobile robot, and a system to operate a method for navigation path tracking control. The device includes: one or more storage media, storing a set of instructions for tracking and controlling a navigation path; and one or more processors in communication with the one or more storage media, wherein during operation the one or more processors execute the set of instructions to: obtain a location of a mobile robot; determine, in a navigation path, a target point that satisfies a preset location relationship with the location of the mobile robot; and control the mobile robot to move toward the target point in the navigation path. In this way, accurate tracking control is implemented on the navigation path of the mobile robot, and accuracy and robustness of tracking control are improved.

### RELATED APPLICATIONS

The present patent document is a continuation of PCT Application Serial No. PCT/CN2018/092592, filed on Jun. 25, 2018, designating the United States and published in Chinese, which is hereby incorporated by reference.

### BACKGROUND

### 1. Technical Field

The present application relates to the field of control technologies, and in particular, to methods, devices, mobile robots, and systems of navigation path tracking control.

### 2. Background Information

Currently, common path tracking control of a mobile robot is mainly to select a coordinate point from a given navigation path as a target point based on a time parameter. Using an aircraft as an example, if the aircraft is affected by an environmental factor such as a gale in a moving process, a location of the aircraft suddenly falls far behind a target point, and as a result, a distance between the aircraft and the target point in a navigation path increases. After the influential factor disappears, the aircraft flies toward the target point along a straight line, and a great deviation is generated between a flight path and the original navigation path. Consequently, system robustness becomes poor, and an unpredictable result easily occurs.

Therefore, how to perform tracking control on the path of the mobile robot more easily and effectively has become a focus of research.

### BRIEF SUMMARY

Embodiments of the present application provide methods, devices, mobile robots, and systems of navigation path tracking control to implement accurate tracking control on a navigation path of a mobile robot and improve accuracy and robustness of tracking control by controlling the mobile robot to move toward the target point that satisfies the preset location relationship with the current location of the mobile robot.

According to a first aspect, embodiments of the present application provide a device for navigation path tracking control of a mobile robot, wherein the device comprises: one or more storage media, storing a set of instructions for tracking and controlling a navigation path; and one or more processors in communication with the one or more storage media, wherein during operation the one or more processors execute the set of instructions to: obtain a location of a mobile robot; determine, in a navigation path, a target point that satisfies a preset location relationship with the location of the mobile robot; and control the mobile robot to move toward the target point in the navigation path.

In some embodiments, the target point is a target point closest to the location of the mobile robot.

In some embodiments, to control the mobile robot to move toward the target point in the navigation path, the one or more processors execute the set of instructions to: determine a radial control error based on a distance between the target point and the location of the mobile robot, and control, based on the radial control error, the mobile robot to move toward the target point in a radial direction of the navigation path at the target point.

In some embodiments, to determine the radial control error, the one or more processors execute the set of instructions to: determine the distance between the target point and the location of the mobile robot as the radial control error.

In some embodiments, during operation the one or more processors further execute the set of instructions to: obtain a velocity of the mobile robot, wherein to control the mobile robot to move toward the target point in a radial direction of the navigation path at the target point, the one or more processors execute the set of instructions to: control, based on the radial control error and the velocity, the mobile robot to move toward the target point in the radial direction of the navigation path at the target point.

In some embodiments, during operation the one or more processors further execute the set of instructions to: obtain a tangential velocity component from the velocity, wherein the tangential velocity is in a tangential direction of the navigation path at the target point; and determine a compensatory centripetal acceleration based on the tangential velocity and a radius of curvature of the navigation path at the target point, wherein to control the mobile robot to move toward the target point in the radial direction of the navigation path at the target point, the one or more processors execute the set of instructions to: control, based on the radial control error and the compensatory centripetal acceleration, the mobile robot to move toward the target point in the radial direction of the navigation path at the target point.

In some embodiments, during operation the one or more processors further execute the set of instructions to: obtain a radial velocity component from the velocity, wherein the radial velocity is in the radial direction of the navigation path at the target point, wherein to control the mobile robot to move toward the target point in the radial direction of the navigation path at the target point, the one or more processors execute the set of instructions to: controlling, based on the radial control error, the compensatory centripetal acceleration, and the radial velocity, the mobile robot to move toward the target point in the radial direction of the navigation path at the target point.

In some embodiments, to determine the target point, the one or more processors execute the set of instructions to: determine, by using a reference point in the navigation path as a start point, the target point in the navigation path in a preset length range along the navigation path.

In some embodiments, the reference point is a previous target point.

In some embodiments, during operation the one or more processors further execute the set of instructions to: obtain a maximum tangential velocity of the mobile robot at the target point; and controlling a tangential velocity of the mobile robot, so that when the mobile robot arrives at the target point, the tangential velocity of the mobile robot is less than the maximum tangential velocity, wherein the tangential velocity is in a tangential direction of the navigation path at the target point.

In some embodiments, to obtain the maximum tangential velocity of the mobile robot at the target point, the one or more processors execute the set of instructions to: obtain a radius of curvature of the navigation path at the target point, obtain a maximum motion posture of the mobile robot, and determine the maximum tangential velocity of the mobile robot at the target point based on the radius of curvature and the maximum motion posture.

In some embodiments, during operation the one or more processors further execute the set of instructions to: obtain at least one sharp turning point in the navigation path; obtain a maximum tangential velocity of the mobile robot at each sharp turning point; and control a tangential velocity of the mobile robot, so that when the mobile robot arrives at each sharp turning point, the tangential velocity of the mobile robot is less than the maximum tangential velocity corresponding to the sharp turning point.

In some embodiments, to obtain the maximum tangential velocity of the mobile robot at each sharp turning point, the one or more processors execute the set of instructions to: obtain a radius of curvature of the navigation path at each sharp turning point, obtain a maximum motion posture of the mobile robot, and determine the maximum tangential velocity of the mobile robot at each sharp turning point based on the radius of curvature and the maximum motion posture.

In some embodiments, to obtain the location of the mobile robot, the one or more processors execute the set of instructions to: obtain a measured location output by a positioning sensor of the mobile robot, and modify the measured location based on a system delay, to obtain the location of the mobile robot.

According to a second aspect, embodiments of the present application provide another navigation path tracking control method for a mobile robot, where the method includes: obtaining a maximum tangential velocity of the mobile robot at a point in a navigation path; and controlling a tangential velocity of the mobile robot, so that when the mobile robot arrives at the point, the tangential velocity of the mobile robot is less than or equal to the maximum tangential velocity.

In some embodiments, the obtaining a maximum tangential velocity of the mobile robot at a point in a navigation path comprises: obtaining a radius of curvature of the point in the navigation path; obtaining a maximum motion posture of the mobile robot; and determining the maximum tangential velocity of the mobile robot at the point based on the radius of curvature and the maximum motion posture.

In some embodiments, the point is a sharp turning point in the navigation path.

In some embodiments, the controlling a tangential velocity of the mobile robot comprises: determining a distance between the mobile robot in a navigation path direction and the point in the navigation path; and if the distance is less than or equal to a preset distance threshold and the tangential velocity of the mobile robot is greater than or equal to the maximum tangential velocity, controlling the mobile robot to reduce the speed, so that when the mobile robot arrives at the point, the tangential velocity of the mobile robot is less than or equal to the maximum tangential velocity corresponding to the sharp turning point.

In some embodiments, the determining a distance between the mobile robot in a navigation path direction and the point in the navigation path comprises: determining the distance between the mobile robot in the navigation path direction and the point in the navigation path based on a location of the mobile robot and a location of the point.

In some embodiments, the method further comprises: obtaining a measured location output by a positioning sensor of the mobile robot; and modifying the measured location based on a system delay, to obtain the location of the mobile robot.

According to a third aspect, embodiments of the present application provide a method for navigation path tracking control, wherein the method comprises: obtaining a location of a mobile robot; determining, in a navigation path, a target point that satisfies a preset location relationship with the location of the mobile robot; and controlling the mobile robot to move toward the target point in the navigation path.

In some embodiments, the target point is a target point closest to the location of the mobile robot.

In some embodiments, the controlling of the mobile robot to move toward the target point in the navigation path includes: determining a radial control error based on a distance between the target point and the location of the mobile robot; and controlling, based on the radial control error, the mobile robot to move toward the target point in a radial direction of the navigation path at the target point.

In some embodiments, the determining of the radial control error includes: determining the distance between the target point and the location of the mobile robot as the radial control error.

In some embodiments, the method further comprises: obtaining a velocity of the mobile robot; and the controlling of the mobile robot to move toward the target point in the radial direction of the navigation path at the target point includes: controlling, based on the radial control error and the velocity, the mobile robot to move toward the target point in the radial direction of the navigation path at the target point.

In some embodiments, the method further comprises: obtaining a tangential velocity of the velocity in a tangential direction; and determining compensatory centripetal acceleration based on the tangential velocity and a radius of curvature corresponding to the target point; and the controlling of the mobile robot to move toward the target point in the radial direction of the navigation path at the target point includes: controlling, based on the radial control error and the compensatory centripetal acceleration, the mobile robot to move toward the target point in the radial direction of the navigation path at the target point.

In some embodiments, the method further comprises: obtaining a radial velocity of the velocity in the radial direction; and the controlling of the mobile robot to move toward the target point in the radial direction of the navigation path at the target point includes: controlling, based on the radial control error, the compensatory centripetal acceleration, and the radial velocity, the mobile robot to move toward the target point in the radial direction of the navigation path at the target point.

In some embodiments, the determining of the target point includes: by using a reference point in the navigation path as a start point, determining, in the navigation path in a preset length range in a navigation path direction, the target point that satisfies the preset location relationship with the location of the mobile robot.

In some embodiments, the reference point is a previous target point.

In some embodiments, the method further comprises: obtaining a maximum tangential velocity of the mobile robot at the target point; and controlling the tangential velocity of the mobile robot, so that when the mobile robot arrives at the target point, the tangential velocity of the mobile robot is less than or equal to the maximum tangential velocity.

In some embodiments, the obtaining the maximum tangential velocity of the mobile robot at the target point includes: obtaining the radius of curvature of the target point in the navigation path; obtaining a maximum motion posture of the mobile robot; and determining the maximum tangential velocity of the mobile robot at the target point based on the radius of curvature and the maximum motion posture.

In some embodiments, the method further comprises: obtaining at least one sharp turning point in the navigation path; obtaining a maximum tangential velocity of the mobile robot at each sharp turning point; and controlling a tangential velocity of the mobile robot, so that when the mobile robot arrives at each sharp turning point, the tangential velocity of the mobile robot is less than or equal to the maximum tangential velocity corresponding to the sharp turning point.

In some embodiments, the obtaining of the maximum tangential velocity of the mobile robot at each sharp turning point includes: obtaining a radius of curvature of the navigation path at each sharp turning point; obtaining a maximum motion posture of the mobile robot; and determining the maximum tangential velocity of the mobile robot at each sharp turning point based on the radius of curvature and the maximum motion posture.

In some embodiments, the obtaining of the location of the mobile robot includes: obtaining a measured location output by a positioning sensor of the mobile robot; and modifying the measured location based on a system delay, to obtain the location of the mobile robot.

According to a fourth aspect, embodiments of the present application provide another navigation path tracking control device, including one or more storage media, storing a set of instructions for tracking and controlling a navigation path; and one or more processors in communication with the one or more storage media, wherein during operation the one or more processors execute the set of instructions to: obtain a maximum tangential velocity of a mobile robot on a point in a navigation path; and control a tangential velocity of the mobile robot, so that when the mobile robot arrives at the point, the tangential velocity of the mobile robot is less than or equal to the maximum tangential velocity.

In some embodiments, when obtaining the maximum tangential velocity of the mobile robot at the point in the navigation path, the processor is specifically configured to: obtain a radius of curvature of the point in the navigation path; obtain a maximum motion posture of the mobile robot; and determine the maximum tangential velocity of the mobile robot at the point based on the radius of curvature and the maximum motion posture.

In some embodiments, the point is a sharp turning point in the navigation path.

In some embodiments, when controlling the tangential velocity of the mobile robot, the processor is specifically configured to: determine a distance between the mobile robot in a navigation path direction and the point in the navigation path; and if the distance is less than or equal to a preset distance threshold and the tangential velocity of the mobile robot is greater than or equal to the maximum tangential velocity, control the mobile robot to reduce the speed, so that when the mobile robot arrives at the point, the tangential velocity of the mobile robot is less than or equal to the maximum tangential velocity corresponding to the sharp turning point.

In some embodiments, when determining the distance between the mobile robot in the navigation path direction and the point in the navigation path, the processor is specifically configured to: determine the distance between the mobile robot in the navigation path direction and the point in the navigation path based on a location of the mobile robot and a location of the point.

In some embodiments, the processor is further configured to: obtain a measured location output by a positioning sensor of the mobile robot; and modify the measured location based on a system delay, to obtain the location of the mobile robot.

According to a fifth aspect, embodiments of the present application provide a mobile robot, including: a body; a power system, configured on the body, and configured to supply power to the mobile robot for moving; and a processor, configured to perform the following steps: obtaining a location of the mobile robot; determining, in a navigation path, a target point that satisfies a preset location relationship with the location of the mobile robot; and controlling the mobile robot to move toward the target point in the navigation path.

In some embodiments, the target point that satisfies the preset location relationship with the location of the mobile robot is a target point closest to the location of the mobile robot.

In some embodiments, when controlling the mobile robot to move toward the target point in the navigation path, the processor is specifically configured to: determine a radial control error based on a distance between the target point and the location of the mobile robot; and control, based on the radial control error, the mobile robot to move toward the target point in a radial direction of the navigation path at the target point.

In some embodiments, when determining the radial control error based on the distance between the target point and the location of the mobile robot, the processor is specifically configured to: determine the distance between the target point and the location of the mobile robot as the radial control error.

In some embodiments, the processor is further configured to: obtain a velocity of the mobile robot; and when controlling, based on the radial control error, the mobile robot to move toward the target point in the radial direction of the navigation path at the target point, the processor is specifically configured to: control, based on the radial control error and the velocity, the mobile robot to move toward the target point in the radial direction of the navigation path at the target point.

In some embodiments, the processor is further configured to: obtain a tangential velocity of the velocity in a tangential direction; and determine compensatory centripetal acceleration based on the tangential velocity and a radius of curvature corresponding to the target point; and when controlling, based on the radial control error and the velocity, the mobile robot to move toward the target point in the radial direction of the navigation path at the target point, the processor is specifically configured to: control, based on the radial control error and the compensatory centripetal acceleration, the mobile robot to move toward the target point in the radial direction of the navigation path at the target point.

In some embodiments, the processor is further configured to: obtain a radial velocity of the velocity in the radial direction; and when controlling, based on the radial control error and the velocity, the mobile robot to move toward the target point in the radial direction of the navigation path at the target point, the processor is specifically configured to: control, based on the radial control error, the compensatory centripetal acceleration, and the radial velocity, the mobile robot to move toward the target point in the radial direction of the navigation path at the target point.

In some embodiments, when determining, in the navigation path, the target point that satisfies the preset location relationship with the location of the mobile robot, the processor is specifically configured to: by using a reference point in the navigation path as a start point, determine, in the navigation path in a preset length range in a navigation path direction, the target point that satisfies the preset location relationship with the location of the mobile robot.

In some embodiments, the reference point is a previous target point.

In some embodiments, the processor is further configured to: obtain a maximum tangential velocity of the mobile robot at the target point; and control the tangential velocity of the mobile robot, so that when the mobile robot arrives at the target point, the tangential velocity of the mobile robot is less than or equal to the maximum tangential velocity.

In some embodiments, when obtaining the maximum tangential velocity of the mobile robot at the target point, the processor is specifically configured to: obtain the radius of curvature of the target point in the navigation path; obtain a maximum motion posture of the mobile robot; and determine the maximum tangential velocity of the mobile robot at the target point based on the radius of curvature and the maximum motion posture.

In some embodiments, the processor is further configured to: obtain at least one sharp turning point in the navigation path; obtain a maximum tangential velocity of the mobile robot on each sharp turning point; and control a tangential velocity of the mobile robot, so that when the mobile robot arrives at each sharp turning point, the tangential velocity of the mobile robot is less than or equal to the maximum tangential velocity corresponding to the sharp turning point.

In some embodiments, when obtaining the maximum tangential velocity of the mobile robot on each sharp turning point, the processor is specifically configured to: obtain a radius of curvature of each sharp turning point in the navigation path; obtain a maximum motion posture of the mobile robot; and determine the maximum tangential velocity of the mobile robot on each sharp turning point based on the radius of curvature and the maximum motion posture.

In some embodiments, when obtaining the location of the mobile robot, the processor is specifically configured to: obtain a measured location output by a positioning sensor of the mobile robot; and modify the measured location based on a system delay, to obtain the location of the mobile robot.

According to a sixth aspect, embodiments of the present application provide another mobile robot, including: a body; a power system, configured on the body, and configured to supply power to the mobile robot for moving; and a processor, configured to perform the following steps: obtaining a maximum tangential velocity of the mobile robot on a point in a navigation path; and controlling a tangential velocity of the mobile robot, so that when the mobile robot arrives at the point, the tangential velocity of the mobile robot is less than or equal to the maximum tangential velocity.

In some embodiments, when obtaining the maximum tangential velocity of the mobile robot at the point in the navigation path, the processor is specifically configured to: obtain a radius of curvature of the point in the navigation path; obtain a maximum motion posture of the mobile robot; and determine the maximum tangential velocity of the mobile robot at the point based on the radius of curvature and the maximum motion posture.

In some embodiments, the point is a sharp turning point in the navigation path.

In some embodiments, when controlling the tangential velocity of the mobile robot, the processor is specifically configured to: determine a distance between the mobile robot in a navigation path direction and the point in the navigation path; and if the distance is less than or equal to a preset distance threshold and the tangential velocity of the mobile robot is greater than or equal to the maximum tangential velocity, control the mobile robot to reduce the speed, so that when the mobile robot arrives at the point, the tangential velocity of the mobile robot is less than or equal to the maximum tangential velocity corresponding to the sharp turning point.

In some embodiments, when determining the distance between the mobile robot in the navigation path direction and the point in the navigation path, the processor is specifically configured to: determine the distance between the mobile robot in the navigation path direction and the point in the navigation path based on a location of the mobile robot and a location of the point.

In some embodiments, the processor is further configured to: obtain a measured location output by a positioning sensor of the mobile robot; and

modify the measured location based on a system delay, to obtain the location of the mobile robot.

According to a seventh aspect, embodiments of the present application provide a navigation path tracking control system, including a navigation path tracking control device and a mobile robot, where the navigation path tracking control device is configured to: obtain a location of the mobile robot; determine, in a navigation path, a target point that satisfies a preset location relationship with the location of the mobile robot; and send a control instruction to the mobile robot, where the control instruction is used to control the mobile robot to move toward the target point in the navigation path; and the mobile robot is configured to move toward the target point in the navigation path in response to the control instruction.

In some embodiments, the target point that satisfies the preset location relationship with the location of the mobile robot is a target point closest to the location of the mobile robot.

In some embodiments, the navigation path tracking control device is specifically configured to: determine a radial control error based on a distance between the target point and the location of the mobile robot; and control, based on the radial control error, the mobile robot to move toward the target point in a radial direction of the navigation path at the target point.

In some embodiments, the navigation path tracking control device is specifically configured to determine the distance between the target point and the location of the mobile robot as the radial control error.

In some embodiments, the navigation path tracking control device is further configured to: obtain a velocity of the mobile robot; and control, based on the radial control error and the velocity, the mobile robot to move toward the target point in the radial direction of the navigation path at the target point.

In some embodiments, the navigation path tracking control device is further configured to: obtain a tangential velocity of the velocity in a tangential direction; determine compensatory centripetal acceleration based on the tangential velocity and a radius of curvature corresponding to the target point; and control, based on the radial control error and the compensatory centripetal acceleration, the mobile robot to move toward the target point in the radial direction of the navigation path at the target point.

In some embodiments, the navigation path tracking control device is further configured to: obtain a radial velocity of the velocity in the radial direction; and control, based on the radial control error, the compensatory centripetal acceleration, and the radial velocity, the mobile robot to move toward the target point in the radial direction of the navigation path at the target point.

In some embodiments, the navigation path tracking control device is specifically configured to: by using a reference point in the navigation path as a start point, determine, in the navigation path in a preset length range in a navigation path direction, the target point that satisfies the preset location relationship with the location of the mobile robot.

In some embodiments, the reference point is a previous target point.

In some embodiments, the navigation path tracking control device is further configured to: obtain a maximum tangential velocity of the mobile robot at the target point; and control the tangential velocity of the mobile robot, so that when the mobile robot arrives at the target point, the tangential velocity of the mobile robot is less than or equal to the maximum tangential velocity.

In some embodiments, the navigation path tracking control device is specifically configured to: obtain the radius of curvature of the target point in the navigation path; obtain a maximum motion posture of the mobile robot; and determine the maximum tangential velocity of the mobile robot at the target point based on the radius of curvature and the maximum motion posture.

In some embodiments, the navigation path tracking control device is further configured to: obtain at least one sharp turning point in the navigation path; obtain a maximum tangential velocity of the mobile robot on each sharp turning point; and control a tangential velocity of the mobile robot, so that when the mobile robot arrives at each sharp turning point, the tangential velocity of the mobile robot is less than or equal to the maximum tangential velocity corresponding to the sharp turning point.

In some embodiments, the navigation path tracking control device is specifically configured to: obtain a radius of curvature of each sharp turning point in the navigation path; obtain a maximum motion posture of the mobile robot; and determine the maximum tangential velocity of the mobile robot on each sharp turning point based on the radius of curvature and the maximum motion posture.

In some embodiments, the navigation path tracking control device is specifically configured to: obtain a measured location output by a positioning sensor of the mobile robot; and modify the measured location based on a system delay, to obtain the location of the mobile robot.

According to an eighth aspect, embodiments of the present application provide another navigation path tracking control system, including a navigation path tracking control device and a mobile robot, where the navigation path tracking control device is configured to: obtain a maximum tangential velocity of the mobile robot at a point in a navigation path; and send a mobility control instruction to the mobile robot, where the mobility control instruction is used to control a tangential velocity of the mobile robot, so that when the mobile robot arrives at the point, the tangential velocity of the mobile robot is less than or equal to the maximum tangential velocity; and the mobile robot is configured to move in the navigation path in response to the mobility control instruction.

In some embodiments, the navigation path tracking control device is specifically configured to: obtain a radius of curvature of the point in the navigation path; obtain a maximum motion posture of the mobile robot; and determine the maximum tangential velocity of the mobile robot at the point based on the radius of curvature and the maximum motion posture.

In some embodiments, the point is a sharp turning point in the navigation path.

In some embodiments, the navigation path tracking control device is specifically configured to: determine a distance between the mobile robot in a navigation path direction and the point in the navigation path; and if the distance is less than or equal to a preset distance threshold and the tangential velocity of the mobile robot is greater than or equal to the maximum tangential velocity, control the mobile robot to reduce the speed, so that when the mobile robot arrives at the point, the tangential velocity of the mobile robot is less than or equal to the maximum tangential velocity corresponding to the sharp turning point.

In some embodiments, the navigation path tracking control device is specifically configured to determine the distance between the mobile robot in the navigation path direction and the point in the navigation path based on a location of the mobile robot and a location of the point.

In some embodiments, the navigation path tracking control device is further configured to: obtain a measured location output by a positioning sensor of the mobile robot; and modify the measured location based on a system delay, to obtain the location of the mobile robot.

According to a ninth aspect, embodiments of the present application provide a computer-readable storage medium, where the computer-readable storage medium stores a computer program, and when the computer program is executed by a processor, the navigation path tracking control method for a mobile robot according to the first aspect or the second aspect is implemented.

In the embodiments of the present application, the location of the mobile robot is obtained; the target point that satisfies the preset location relationship with the location of the mobile robot is determined in the navigation path; and the mobile robot is controlled to move toward the target point in the navigation path. In this way, accurate tracking control is implemented on the navigation path of the mobile robot, and accuracy and robustness of tracking control are improved.

### BRIEF DESCRIPTION OF THE DRAWINGS

To describe the technical solutions in the embodiments of the present application or in the conventional techniques more clearly, the following briefly describes the accompanying drawings required for describing the embodiments. Apparently, the accompanying drawings in the following description show merely some embodiments of the present application, and a person of ordinary skill in the art may still derive other drawings from these accompanying drawings without creative efforts.

FIG. 1 is a schematic structural diagram of a navigation path tracking control system according to some embodiments of the present application;

FIG. 2 is a schematic flowchart of a navigation path tracking control method according to some embodiments of the present application;

FIG. 3 is a schematic interface diagram of a mobile robot and a navigation path according to some embodiments of the present application;

FIG. 4 is another schematic interface diagram of a mobile robot and a navigation path according to some embodiments of the present application;

FIG. 5 is a schematic flowchart of another navigation path tracking control method according to some embodiments of the present application;

FIG. 6 is a schematic force analysis interface diagram of a mobile robot according to some embodiments of the present application;

FIG. 7 is a schematic flowchart of still another navigation path tracking control method according to some embodiments of the present application;

FIG. 8 is a schematic interface diagram of a mobile robot on a sharp turning point and a navigation path according to some embodiments of the present application;

FIG. 9 is a schematic flowchart of still another navigation path tracking control method according to some embodiments of the present application;

FIG. 10 is a schematic structural diagram of a navigation path tracking control device according to some embodiments of the present application; and

FIG. 11 is a schematic structural diagram of another navigation path tracking control device according to some embodiments of the present application.

### DETAILED DESCRIPTION OF THE DRAWINGS

The following description provides specific application scenarios and requirements of the present application in order to enable those skilled in the art to make and use the present application. Various modifications to the disclosed embodiments will be apparent to those skilled in the art. The general principles defined herein may be applied to other embodiments and applications without departing from the spirit and scope of the disclosure. Therefore, the present disclosure is not limited to the embodiments shown, but the broadest scope consistent with the claims.

The terminology used herein is for the purpose of describing particular exemplary embodiments only and is not intended to be limiting. As used herein, the singular forms “a”, “an” and “the” may include their plural forms as well, unless the context clearly indicates otherwise. When used in this disclosure, the terms “comprises”, “comprising”, “includes” and/or “including” refer to the presence of stated features, integers, steps, operations, elements, and/or components, but do not preclude the presence or addition of one or more other features, integers, steps, operations, elements, components, and/or groups thereof. As used in this disclosure, the term “A on B” means that A is directly adjacent to B (from above or below), and may also mean that A is indirectly adjacent to B (i.e., there is some element between A and B); the term “A in B” means that A is all in B, or it may also mean that A is partially in B.

In view of the following description, these and other features of the present disclosure, as well as operations and functions of related elements of the structure, and the economic efficiency of the combination and manufacture of the components, may be significantly improved. All of these form part of the present disclosure with reference to the drawings. However, it should be clearly understood that the drawings are only for the purpose of illustration and description, and are not intended to limit the scope of the present disclosure. It is also understood that the drawings are not drawn to scale.

In some embodiments, numbers expressing quantities or properties used to describe or define the embodiments of the present application should be understood as being modified by the terms “about”, “generally”, “approximate,” or “substantially” in some instances. For example, “about”, “generally”, “approximately” or “substantially” may mean a ±20% change in the described value unless otherwise stated. Accordingly, in some embodiments, the numerical parameters set forth in the written description and the appended claims are approximations, which may vary depending upon the desired properties sought to be obtained in a particular embodiment. In some embodiments, numerical parameters should be interpreted in accordance with the value of the parameters and by applying ordinary rounding techniques. Although a number of embodiments of the present application provide a broad range of numerical ranges and parameters that are approximations, the values in the specific examples are as accurate as possible.

Each of the patents, patent applications, patent application publications, and other materials, such as articles, books, instructions, publications, documents, products, etc., cited herein are hereby incorporated by reference, which are applicable to all contents used for all purposes, except for any history of prosecution documents associated therewith, or any identical prosecution document history, which may be inconsistent or conflicting with this document, or any such subject matter that may have a restrictive effect on the broadest scope of the claims associated with this document now or later. For example, if there is any inconsistent or conflicting in descriptions, definitions, and/or use of a term associated with this document and descriptions, definitions, and/or use of the term associated with any materials, the term in this document shall prevail.

It should be understood that the embodiments of the application disclosed herein are merely described to illustrate the principles of the embodiments of the application. Other modified embodiments are also within the scope of this application. Therefore, the embodiments disclosed herein are by way of example only and not limitations. Those skilled in the art may adopt alternative configurations to implement the invention in this application in accordance with the embodiments of the present application. Therefore, the embodiments of the present application are not limited to those embodiments that have been precisely described in this disclosure.

The following clearly describes the technical solutions in the embodiments of the present application with reference to the accompanying drawings in the embodiments of the present application. Apparently, the described embodiments are merely some but not all of the embodiments of the present application. All other embodiments obtained by a person of ordinary skill in the art based on the embodiments of the present application without creative efforts shall fall within the protection scope of the present application.

The following describes in detail some implementations of the present application with reference to the accompanying drawings. If no conflict occurs, the following embodiments and features in the embodiments may be mutually combined.

A navigation path tracking control method for a mobile robot according to the embodiments of the present application may be performed by a navigation path tracking control system, where the navigation path tracking control system may include a navigation path tracking control device and a mobile robot. In some embodiments, the navigation path tracking control device may be mounted on the mobile robot. In some embodiments, the navigation path tracking control device may be independent of the mobile robot in space. In some embodiments, the navigation path tracking control device may be a component of the mobile robot, that is, the mobile robot may include the navigation path tracking control device. The mobile robot may include a robot that can move, such as an unmanned aerial vehicle, an unmanned vehicle, or an unmanned surface vehicle. The navigation path tracking control device and the mobile robot may perform bidirectional communication. The navigation path tracking control device in the navigation path tracking control system may obtain a location of the mobile robot in real time in a moving process of the mobile robot, determine, in a navigation path, a target point that satisfies a preset location relationship with the location of the mobile robot, and control the mobile robot to move toward the target point in the navigation path. The location of the mobile robot that is obtained by the navigation path tracking control device may be a current location of the mobile robot that is obtained in the moving process of the mobile robot.

In some embodiments, the navigation path may be obtained by the navigation path tracking control device from a control terminal. In some embodiments, the control terminal may determine the navigation path by detecting a navigation path planning operation of a user, and send the navigation path to the navigation path tracking device over a wired or wireless data link. In some embodiments, alternatively, the navigation path may be planned by the navigation path tracking control device. For example, when the mobile robot performs a work task (such as a photographing task, an agricultural operation task, or a return task), the navigation tracking control device may plan the navigation path.

In some embodiments, the navigation path may include a plurality of points. The navigation path tracking control device may determine, from the plurality of points in the navigation path, a target point that satisfies the preset location relationship with the location of the mobile robot, and control the mobile robot to move toward the target point. In some embodiments, in each control period of the navigation path tracking control device, the navigation path tracking control device may determine, from the navigation path, a target point that satisfies the preset location relationship with the location of the mobile robot, and control the mobile robot to move toward the target point. The target point that satisfies the preset location relationship with the location of the mobile robot may be a target point closest to the location of the mobile robot in the navigation path. In some embodiments, the target point that satisfies the preset location relationship with the location of the mobile robot may alternatively be a target point that satisfies another relationship. This is not specifically limited in the embodiments of the present application.

In some embodiments, the navigation path tracking control method for the mobile robot may be applied to another mobile device, for example, a mobile device that can move autonomously, such as a robot, an unmanned aerial vehicle, an unmanned vehicle, or an unmanned surface vehicle. The following describes the navigation path tracking control system provided by the embodiments of the present application. For ease of description, the following describes an example in which an unmanned aerial vehicle is a mobile robot.

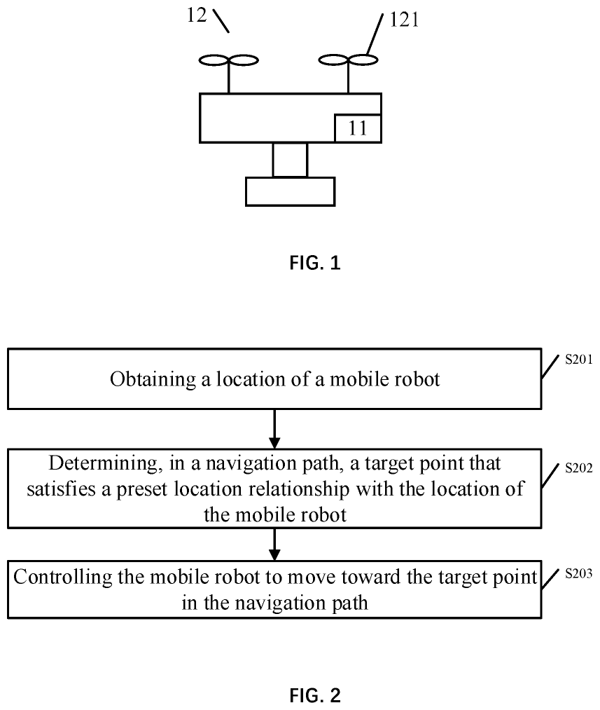

FIG. 1 is a schematic structural diagram of a navigation path tracking control system according to some embodiments of the present application. The navigation path tracking control system may include a navigation path tracking control device 11 and a mobile robot 12. A communication connection may be established between the mobile robot 12 and the navigation path tracking control device 11 in a wireless communication connection manner. In some specific scenarios, alternatively, a communication connection may be established between the mobile robot 12 and the navigation path tracking control device 11 in a wired communication connection manner. The mobile robot 12 may be a rotor aircraft, for example, a four-rotor aircraft, a six-rotor aircraft, or an eight-rotor aircraft, or may be an aircraft such as a fixed-rotor aircraft. The mobile robot 12 may include a power system 121, where the power system 121 is configured to supply power to the mobile robot 12 for moving. The mobile robot 12 may include a positioning sensor, where the positioning sensor is configured to obtain a measured location of the mobile robot, and may determine a location of the mobile robot based on the measured location.

In this embodiment of the present application, the navigation path tracking control device 11 may obtain the location of the mobile robot 12 by using the measured location output by the positioning sensor, determine, in a navigation path, a target point that satisfies a preset location relationship with the location of the mobile robot 12, and send a control instruction to the mobile robot 12, to control the mobile robot 12 to move toward the target point in the navigation path.

In the implementation of the present application, by using the location relationship between the location of the mobile robot and the navigation path, the mobile robot may be controlled to track the navigation path. To be specific, by using the location relationship between the location of the mobile robot and the point in the navigation path, the point in the navigation path may be selected, so that the mobile robot is controlled to track the navigation path. Therefore, accurate consistency between a moving track of the mobile robot and the navigation path may be achieved. This may overcome a problem in a conventional mode that a point in a navigation path is selected based on a time parameter to control a mobile robot to track the navigation path, overcome a problem that a great deviation exists between a moving track of the mobile robot and the navigation path, and improve accuracy of navigation path tracking.

In some embodiments, when the navigation path tracking control device 11 controls the mobile robot 12 to move toward the target point in the navigation path, the navigation path tracking control device 11 may obtain a maximum tangential velocity of the mobile robot 12 at the target point in the navigation path, and send a mobility control instruction to the mobile robot 12, so that when the mobile robot 12 arrives at the point, a tangential velocity of the mobile robot 12 is less than or equal to the maximum tangential velocity. In this implementation, the mobile robot moving in the navigation path may be prevented from departing from the navigation path, so that the mobile robot may strictly move along the navigation path.

The following describes a navigation path tracking control method for a mobile robot with reference to an accompanying drawing by using an example.

FIG. 2 is a schematic flowchart of a navigation path tracking control method according to some embodiments of the present application. The method may be performed by a navigation path tracking control device, where detailed explanations about the navigation path tracking control device are the same as above. In some embodiments, the method in this embodiment of the present application may include the following steps.

S201. Obtaining a location of a mobile robot.

In this embodiment of the present application, the navigation path tracking control device may obtain the location of the mobile robot in real time.

In some embodiments, the navigation path tracking control device may obtain a measured location output by a positioning sensor of the mobile robot, and modify the measured location based on a determined system delay, to obtain a current location of the mobile robot in a moving process. In a specific implementation process, the navigation path tracking control device may obtain the system delay by using a preset predictive compensator, and therefore modify the measured location based on the obtained system delay, to obtain the current location of the mobile robot in the moving process.

In some embodiments, in a process of obtaining the system delay by using the preset predictive compensator, the navigation path tracking control device may create a system model in an experiment mode to perform sample training, calculate the system delay by using the created system model, and modify the measured location based on the system delay, to obtain the current location of the mobile robot in the moving process. For example, assuming that a system uses a classic Smith predictive compensator, by recording a historical control instruction and a historical system status (rate), in combination with the created system model, the system may predict a system status after several periods to obtain the system delay, and modify, based on the obtained system delay, the measured location output by the positioning sensor in the mobile robot, to obtain the current location of the mobile robot in the moving process.

S202. Determining, in a navigation path, a target point that satisfies a preset location relationship with the location of the mobile robot.

In this embodiment of the present application, the navigation path tracking control device may determine, in the navigation path, the target point that satisfies the preset location relationship with the location of the mobile robot. In some embodiments, the target point that satisfies the preset location relationship with the location of the mobile robot is a target point closest to the location of the mobile robot. For example, in each working period, the navigation path tracking control device determines, from a plurality of points included in the navigation path, a point closest to the location of the mobile robot, that is, a target point.

In some embodiments, the navigation path tracking control device may determine, in the navigation path in a preset length range in a navigation path direction by using a reference point in the navigation path as a start point, the target point closest to the location of the mobile robot. The reference point may be a previous target point. This implementation may avoid missing a part of the navigation path during target point selection, and ensure that the mobile robot moves along the navigation path when moving toward the target point.

In some embodiments, the navigation path tracking control device may calculate a distance between the mobile robot and any point in the navigation path in the preset length range in the navigation path direction by using the reference point in the navigation path as the start point and using a closest point search algorithm, and determine the point closest to the mobile robot in the navigation path as the target point based on a distance obtained through calculation between the mobile robot and each point in the navigation path.

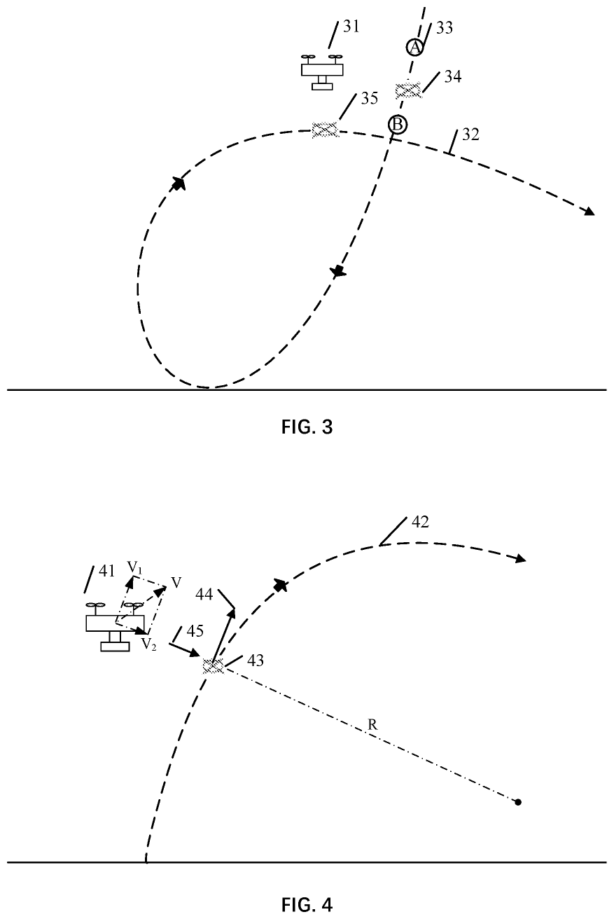

An implementation process may be described by using FIG. 3 as an example. FIG. 3 is a schematic interface diagram of a mobile robot and a navigation path according to some embodiments of the present application. As shown in FIG. 3, the mobile robot is an aircraft 31, and the aircraft 31 may deviate from a navigation path 32. If the navigation path tracking control device determines, in the navigation path 32 by using the closest point search algorithm, that points closest to the aircraft 31 include a point 34 and a point 35, the navigation path tracking control device may determine a target point from the point 34 and the point 35. Because a previous target point in the navigation path 32 is a point 33, the navigation path tracking control device may determine, in a navigation path direction by using the previous target point 33 as a start point, that a preset length range is AB, therefore may determine that the point 34 is in the preset length range AB and that the point 35 is beyond the preset length range AB, and therefore may determine that the point 34 is a target point closest to the aircraft 31 in the preset length range AB in the navigation path direction.

S203. Controlling the mobile robot to move toward the target point in the navigation path.

In this embodiment of the present application, after determining, in the navigation path, the target point that satisfies the preset location relationship with the location of the mobile robot, the navigation path tracking control device may control the mobile robot to move toward the target point in the navigation path. In this way, the mobile robot may be controlled to track the navigation path.

In some embodiments, the navigation path tracking control device may determine a radial control error based on a distance between the target point and the location of the mobile robot, and control, based on the radial control error, the mobile robot to move toward the target point in a radial direction of the navigation path at the target point. In some cases, the navigation path tracking control device may directly determine the distance between the target point and the location of the mobile robot as the radial control error. For example, the target point that satisfies the preset location relationship with the location of the mobile robot may be the target point closest to the location of the mobile robot, and the distance between the target point and the location of the mobile robot may be directly determined as the radial control error. In some embodiments, based on the radial control error, the mobile robot may be controlled to move toward the target point. For example, a radial speed control instruction may be generated based on the radial control error, and the mobile robot may control, based on the radial speed control instruction, a power system to generate power to enable the mobile robot to move in the radial direction toward the target point.

In some embodiments, the navigation path tracking control device may determine a tangential control error based on a distance between the target point and the location of the mobile robot, and control, based on the tangential control error, the mobile robot to move toward the target point in a tangential direction of the navigation path at the target point. In some cases, the navigation path tracking control device may directly determine the distance between the target point and the location of the mobile robot as the tangential control error. In some embodiments, based on the tangential control error, the mobile robot may be controlled to move toward the target point. For example, a tangential speed control instruction may be generated based on the tangential control error, and the mobile robot may control, based on the tangential speed control instruction, a power system to generate power to enable the mobile robot to move in the tangential direction toward the target point.

In an implementation process, the navigation path tracking control device may receive a navigation path in a piecewise polynomial form, where the navigation path is generated by a path generation module or a control terminal. The path generation module or the control terminal may ensure a smooth connection between navigation path segments, and each navigation path segment may include a polynomial coefficient matrix with three rows and N columns, that is, 3×N, and parameter domains. The piecewise polynomial may be encapsulated into a complete navigation path. Information on the navigation path, for example, a point location, a tangential direction, a radial direction, curvature information (for example, a radius of curvature), and a path length (that is, a length in the navigation path direction), may be directly obtained by using an interface function.

FIG. 4 may be used as an example for description. FIG. 4 is another schematic interface diagram of a mobile robot and a navigation path according to some embodiments of the present application. As shown in FIG. 4, the mobile robot is an aircraft 41, and the schematic diagram may further include a navigation path 42, a target point 43, a tangential moving direction 44, and a radial moving direction 45. The navigation path tracking control device may obtain a coordinate location of the target point 43, determine a radial control error d based on a distance between the coordinate location of the target point 43 and a coordinate location of the aircraft 41, and control, based on the radial control error d, the aircraft 41 to move toward the target point 43 in the radial moving direction 45 of the navigation path 42 at the target point 43.

In some embodiments, the navigation path tracking control device may obtain a velocity of the mobile robot, and control, based on the radial control error and the velocity, the mobile robot to move toward the target point in the radial direction of the navigation path at the target point. The velocity may include a tangential velocity component in the tangential direction and a radial velocity component in the radial direction. The tangential velocity may be in a tangential direction of the navigation path at the target point. The radial velocity may be in the radial direction of the navigation path at the target point. In some embodiments, the mobile robot may have a velocity at the current location, and the velocity may affect control of the mobile robot in the radial direction. Therefore, based on moving of the mobile robot and the radial control error, the mobile robot may need to be controlled to move toward the target point in the radial direction of the navigation path at the target point.

In some embodiments, the navigation path tracking control device may obtain a tangential velocity component from the velocity, wherein the tangential velocity is in the tangential direction of the navigation path at the target point, and determine compensatory centripetal acceleration based on the tangential velocity and a radius of curvature of the navigation path at the target point. The navigation path tracking control device may control, based on the radial control error and the compensatory centripetal acceleration, the mobile robot to move toward the target point in the radial direction of the navigation path at the target point. In some embodiments, in a process of tracking the navigation path by the mobile robot, a centripetal acceleration constraint may be required, so that the mobile robot does not deviate from the navigation path. Therefore, when the mobile robot is controlled to move toward the target point in the radial direction, the centripetal acceleration, that is, the compensatory centripetal acceleration, may need to be added to a control process in the radial direction.

In some embodiments, a value of the tangential velocity of the mobile robot may remain unchanged. The tangential speed of the mobile robot may be fixed by a program of the mobile robot, or may be specified by a user of the mobile robot by using a control terminal. For example, the user expects that the value of the tangential velocity may remain unchanged when the mobile robot tracks the navigation path.

In some embodiments, a value of the tangential velocity of the mobile robot may be variable. For example, when the mobile robot tracks the navigation path, a user may control the value of the tangential velocity in real time by using a control terminal. For another example, in some cases, when a preset condition is satisfied, the value of the tangential velocity of the mobile robot may be variable.

FIG. 4 may be used as an example for description. Assuming that a velocity of the aircraft 41 that is obtained by the navigation path tracking control device is V, if it is determined that a tangential velocity of the velocity V in the tangential direction 44 is V₁, compensatory centripetal acceleration a=V₁²/R may be determined based on the tangential velocity V₁ and a radius R of curvature corresponding to the target point 43. The navigation path tracking control device may control, based on the determined radial control error d and compensatory centripetal acceleration a, the aircraft to move in the radial direction 45 toward the target point in the navigation path 42.

In some embodiments, the navigation path tracking control device may obtain a radial velocity component from the velocity, wherein the radial velocity is in the radial direction of the navigation path at the target point, and control, based on the radial control error, the compensatory centripetal acceleration, and the radial velocity, the mobile robot to move toward the target point in the radial direction of the navigation path at the target point. FIG. 4 may be used as an example for description. The navigation path tracking control device may obtain a radial velocity V₂ of the velocity V of the aircraft 41 in the radial direction 45, and control, based on the determined radial control error d, compensatory centripetal acceleration a, and radial velocity V₂, the aircraft 41 to move toward the target point 43 in the radial direction 45 of the navigation path 42 at the target point 43.

In this embodiment of the present application, the navigation path tracking control device may obtain the location of the mobile robot, determine, in the navigation path, the target point that satisfies the preset location relationship with the location of the mobile robot, and control the mobile robot to move toward the target point in the navigation path. In this way, highly accurate tracking control may be implemented on the navigation path of the mobile robot, and accuracy of tracking control is improved.

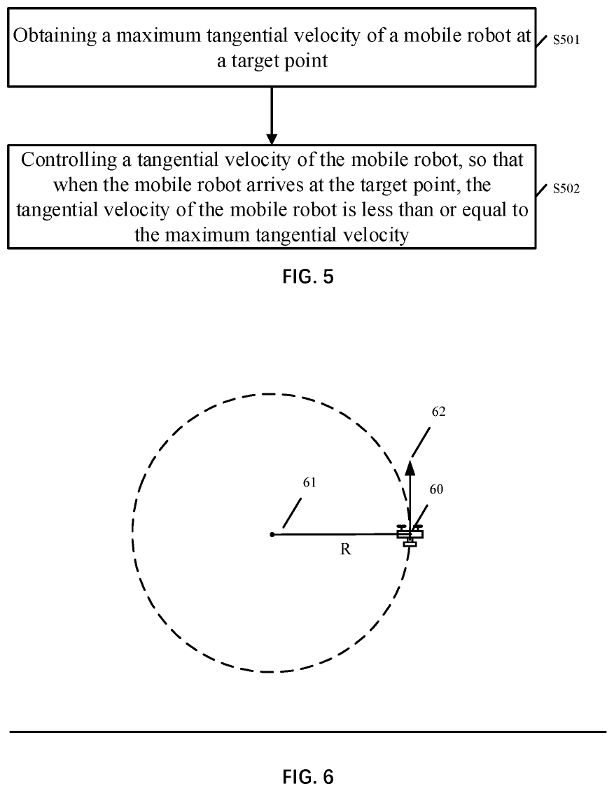

FIG. 5 is a schematic flowchart of another navigation path tracking control method according to some embodiments of the present application. The method may be performed by a navigation path tracking control device, where detailed explanations about the navigation path tracking control device are the same as above. A difference between this embodiment of the present application and the embodiment in FIG. 2 lies in that in this embodiment of the present application, control performed on a tangential velocity of a mobile robot in a navigation path is described in detail. The method in this embodiment of the present application may include the following steps.

S501. Obtaining a maximum tangential velocity of a mobile robot at a target point.

In this embodiment of the present application, after controlling the mobile robot to move to the target point in the navigation path, the navigation path tracking control device may obtain the maximum tangential velocity of the mobile robot at the target point.

In some embodiments, the navigation path tracking control device may obtain a radius of curvature of the navigation path at the target point, obtain a maximum motion posture of the mobile robot, and determine the maximum tangential velocity of the mobile robot at the target point based on the radius of curvature and the maximum motion posture.

FIG. 6 may be used as an example for description. FIG. 6 is a schematic force analysis interface diagram of a mobile robot according to some embodiments of the present application. As shown in FIG. 6, the mobile robot may be an aircraft 60. When the aircraft 60 moves in the navigation path, a radius R of curvature at the target point in a direction 61 in the navigation path may be obtained, and a maximum posture angle θₘₐₓ corresponding to the maximum motion posture of the aircraft 60 may be obtained. The maximum motion posture of the mobile robot may be determined by physical performance of the mobile robot. A maximum tangential velocity V₁ₘₐₓ of the aircraft 60 in a tangential direction 62 at the target point may be determined based on the radius R of curvature and the maximum posture angle θₘₐₓ of the maximum motion posture. The maximum tangential velocity of the aircraft 60 at the target point may be determined through calculation based on a formula V₁ₘₐₓ={square root over ((g·tan(θₘₐₓ)−f)·R)} by using gravity acceleration g in a gravity direction and a drag coefficient f.

S502. Controlling a tangential velocity of the mobile robot, so that when the mobile robot arrives at the target point, the tangential velocity of the mobile robot is less than or equal to the maximum tangential velocity.

In some embodiments, the navigation path tracking control device may control the tangential velocity of the mobile robot. For example, when the mobile robot moves toward the target point, when determining that a current tangential velocity of the mobile robot is large, the navigation path tracking control device may reduce the tangential velocity of the mobile robot, so that when the mobile robot arrives at the target point, the tangential velocity of the mobile robot is less than or equal to the maximum tangential velocity.

In this embodiment of the present application, the navigation path tracking control device may control the tangential velocity of the mobile robot, so that when the mobile robot arrives at the target point, the tangential velocity of the mobile robot is less than or equal to the maximum tangential velocity.

In this embodiment of the present application, the navigation path tracking control device may obtain the maximum tangential velocity of the mobile robot at the target point, and control the tangential velocity of the mobile robot, so that when the mobile robot arrives at the target point, the tangential velocity of the mobile robot is less than or equal to the maximum tangential velocity, to prevent the mobile robot from departing from the navigation path due to an excessively high tangential velocity when the mobile robot moves in the navigation path.

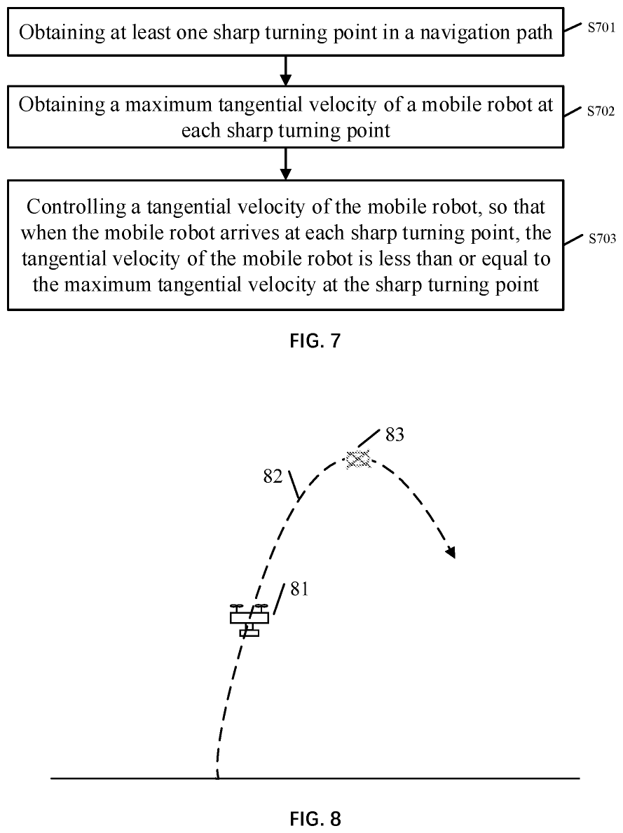

FIG. 7 is a schematic flowchart of still another navigation path tracking control method according to some embodiments of the present application. The method may be performed by a navigation path tracking control device, where detailed explanations about the navigation path tracking control device are the same as above. A difference between this embodiment of the present application and the embodiment in FIG. 5 lies in that in this embodiment of the present application, control performed on a mobile robot on a sharp turning point in a navigation path is described in detail. The method in this embodiment of the present application may include the following steps.

S701. Obtaining at least one sharp turning point in a navigation path.

In this embodiment of the present application, the navigation path tracking control device may obtain at least one sharp turning point in the navigation path. FIG. 8 may be used as an example for description. FIG. 8 is a schematic interface diagram of a mobile robot on a sharp turning point and a navigation path according to some embodiments of the present application. As shown in FIG. 8, the mobile robot may be an aircraft 81, and the schematic interface diagram may further include a navigation path 82 and a sharp turning point 83.

In some embodiments, the navigation path tracking control device may determine locations of all points with maximum curvature in the navigation path based on an expression of a curvature vector by using a numerical method, where each determined point with maximum curvature is a sharp turning point.

S702. Obtaining a maximum tangential velocity of a mobile robot at each sharp turning point.

In this embodiment of the present application, the navigation path tracking control device may obtain the maximum tangential velocity of the mobile robot on each sharp turning point.

In some embodiments, the navigation path tracking control device may determine each sharp turning point in the navigation path by calculating a point with maximum curvature in the navigation path, obtain a radius of curvature of the navigation path at each sharp turning point, and obtain a maximum motion posture of the mobile robot, to determine the maximum tangential velocity of the mobile robot at each sharp turning point based on the radius of curvature and the maximum motion posture.

Using FIG. 8 as an example, assuming that the navigation path 82 includes one sharp turning point 83, when the aircraft 81 moves in the navigation path 82, the navigation path tracking control device may obtain a radius R of curvature of the navigation path 82 at the sharp turning point 83, obtain a maximum posture angle θₘₐₓ corresponding to a maximum motion posture of the aircraft 81, and determine a maximum tangential velocity V₁ₘₐₓ of the aircraft 81 at the sharp turning point 83 based on the radius of curvature R and the maximum posture angle θₘₐₓ corresponding to the maximum motion posture.

S703. Controlling a tangential velocity of the mobile robot, so that when the mobile robot arrives at each sharp turning point, the tangential velocity of the mobile robot is less than or equal to the maximum tangential velocity corresponding to the sharp turning point.

In this embodiment of the present application, the navigation path tracking control device may control the tangential velocity of the mobile robot, so that when the mobile robot arrives at each sharp turning point, the tangential velocity of the mobile robot is less than or equal to the maximum tangential velocity corresponding to the sharp turning point. In this implementation, the mobile robot on the sharp turning point may be prevented from departing from the navigation path, so that the mobile robot may be controlled more effectively to move along the navigation path.

In this embodiment of the present application, the navigation path tracking control device may obtain the at least one sharp turning point in the navigation path, obtain the maximum tangential velocity of the mobile robot on each sharp turning point, and control the tangential velocity of the mobile robot, so that when the mobile robot arrives at each sharp turning point, the tangential velocity of the mobile robot is less than or equal to the maximum tangential velocity corresponding to the sharp turning point, and that the mobile robot moving in the navigation path may be prevented from departing from the navigation path.

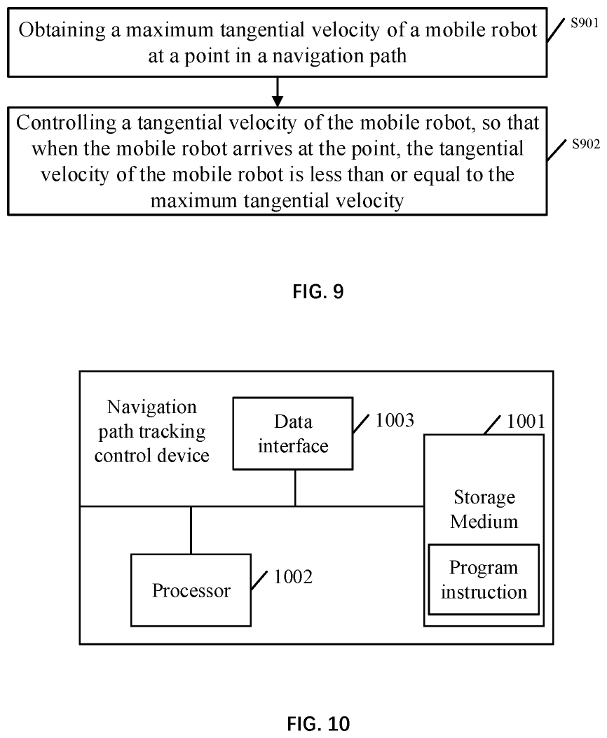

FIG. 9 is a schematic flowchart of still another navigation path tracking control method for a mobile robot according to some embodiments of the present application. The method may be performed by a navigation path tracking control device, where detailed explanations about the navigation path tracking control device are the same as above. In this embodiment of the present application, control performed on a speed of a mobile robot on a point when the mobile robot moves in a navigation path is described in detail. The method in this embodiment of the present application may include the following steps.

S901. Obtaining a maximum tangential velocity of a mobile robot at a point in a navigation path.

In this embodiment of the present application, the navigation path tracking control device may obtain the maximum tangential velocity of the mobile robot at the point in the navigation path. In some embodiments, the point is a sharp turning point in the navigation path.

In some embodiments, the navigation path tracking control device may obtain a radius of curvature of the navigation path at the point in, obtain a maximum motion posture of the mobile robot, and determine the maximum tangential velocity of the mobile robot at the point based on the radius of curvature and the maximum motion posture. A specific implementation process and examples are described above, and are not described again herein.

S902. Controlling a tangential velocity of the mobile robot, so that when the mobile robot arrives at the point, the tangential velocity of the mobile robot is less than or equal to the maximum tangential velocity.

In this embodiment of the present application, the navigation path tracking control device may control the tangential velocity of the mobile robot, so that when the mobile robot arrives at the point, the tangential velocity of the mobile robot is less than or equal to the maximum tangential velocity.

In some embodiments, the navigation path tracking control device may determine a distance between the mobile robot in a navigation path direction and the point in the navigation path; and if the distance is less than or equal to a preset distance threshold and the tangential velocity of the mobile robot is greater than or equal to the maximum tangential velocity, control the mobile robot to reduce the speed, so that when the mobile robot arrives at the point, the tangential velocity of the mobile robot is less than or equal to the maximum tangential velocity corresponding to the sharp turning point.

Using FIG. 8 as an example, assuming that the mobile robot is an aircraft 81, if the navigation path tracking control device determines that a distance between the aircraft 81 in a direction of a navigation path 82 and a point 83 in the navigation path 82 is less than a preset distance threshold, and a tangential velocity of the aircraft 81 is greater than the maximum tangential velocity, the navigation path tracking control device controls the aircraft 81 to reduce the speed, so that when the aircraft 81 arrives at the point 83, the tangential velocity of the aircraft 81 is less than or equal to the maximum tangential velocity corresponding to the sharp turning point 83.

In some embodiments, the navigation path tracking control device may determine the distance between the mobile robot in the navigation path direction and the point in the navigation path based on a location of the mobile robot and a location of the point. In an implementation process, the navigation path tracking control device may calculate a distance between any two points in the navigation path in real time by using a path length integral, where the path length integral algorithm may use a numerical method for calculation, to greatly improve calculation efficiency. In this embodiment of the present application, a Gauss adaptive quadrature algorithm or Newton-Cotes quadrature algorithm may be used to calculate the distance between any two points in the navigation path. The path length integral algorithm is not specifically limited in this embodiment of the present application.

In some embodiments, the navigation path tracking control device may obtain a measured location output by a positioning sensor of the mobile robot, and modify the measured location based on a system delay, to obtain the location of the mobile robot.

In this embodiment of the present application, the navigation path tracking control device may obtain the maximum tangential velocity of the mobile robot at the point in the navigation path, and control the tangential velocity of the mobile robot, so that when the mobile robot arrives at the point, the tangential velocity of the mobile robot is less than or equal to the maximum tangential velocity, and that the mobile robot moving in the navigation path is prevented from departing from the navigation path.

FIG. 10 is a schematic structural diagram of a navigation path tracking control device according to some embodiments of the present application. In some embodiments, the navigation path tracking control device may include a storage media 1001, a processor 1002, and a data interface 1003.

The data interface 1103 may be configured to transfer data information between the navigation path tracking control device and a mobile robot.

The storage media 1001 may include a volatile memory. The storage media 1001 may also include a non-volatile memory. The storage media 1001 may further include a combination of the foregoing types of memories. The processor 1002 may be a central processing unit (CPU). The processor 1002 may further include a hardware chip. The hardware chip may be an application-specific integrated circuit (ASIC), a programmable logic device (PLD), or a combination thereof. The PLD may be a complex programmable logic device (CPLD), a field-programmable gate array (FPGA), or any combination thereof.

The storage media 1001 is configured to store a set of instructions for tracking and controlling a navigation path. The processor 1002 may be in communication with the storage media and invoke the program instruction stored in the storage media 1001. During operation, the processor may execute the set of instructions to perform the following steps: obtaining a location of the mobile robot; determining, in a navigation path, a target point that satisfies a preset location relationship with the location of the mobile robot; and controlling the mobile robot to move toward the target point in the navigation path.

In some embodiments, the target point that satisfies the preset location relationship with the location of the mobile robot may be a target point closest to the location of the mobile robot.

In some embodiments, the processor 1002 may invoke the program instruction stored in the storage media 1001, and when controlling the mobile robot to move toward the target point in the navigation path, may be configured to perform the following steps: determining a radial control error based on a distance between the target point and the location of the mobile robot; and controlling, based on the radial control error, the mobile robot to move toward the target point in a radial direction of the navigation path at the target point.

In some embodiments, the processor 1002 may invoke the program instruction stored in the storage media 1001, and when determining the radial control error based on the distance between the target point and the location of the mobile robot, may be configured to perform the following step: determining the distance between the target point and the location of the mobile robot as the radial control error.

In some embodiments, the processor 1002 may invoke the program instruction stored in the storage media 1001, and may further be configured to perform the following steps: obtaining a velocity of the mobile robot; and controlling, based on the radial control error and the velocity, the mobile robot to move toward the target point in the radial direction of the navigation path at the target point.

In some embodiments, the processor 1002 may invoke the program instruction stored in the storage media 1001, and may further be configured to perform the following steps: obtaining a tangential velocity of the velocity in a tangential direction; determining compensatory centripetal acceleration based on the tangential velocity and a radius of curvature corresponding to the target point; and controlling, based on the radial control error and the compensatory centripetal acceleration, the mobile robot to move toward the target point in the radial direction of the navigation path at the target point.

In some embodiments, the processor 1002 may invoke the program instruction stored in the storage media 1001, and may further be configured to perform the following steps: obtaining a radial velocity of the velocity in the radial direction; and controlling, based on the radial control error, the compensatory centripetal acceleration, and the radial velocity, the mobile robot to move toward the target point in the radial direction of the navigation path at the target point.

In some embodiments, the processor 1002 may invoke the program instruction stored in the storage media 1001, and when determining the target point that satisfies the preset location relationship with the location of the mobile robot in the navigation path, may be configured to perform the following step: by using a reference point in the navigation path as a start point, determining, in the navigation path in a preset length range in a navigation path direction, the target point that satisfies the preset location relationship with the location of the mobile robot.

In some embodiments, the reference point may be a previous target point.

In some embodiments, the processor 1002 may invoke the program instruction stored in the storage media 1001, and may further be configured to perform the following steps: obtaining a maximum tangential velocity of the mobile robot at the target point; and controlling the tangential velocity of the mobile robot, so that when the mobile robot arrives at the target point, the tangential velocity of the mobile robot is less than or equal to the maximum tangential velocity.

In some embodiments, the processor 1002 may invoke the program instruction stored in the storage media 1001, and when obtaining the maximum tangential velocity of the mobile robot at the target point, may be configured to perform the following steps: obtaining the radius of curvature of the target point in the navigation path; obtaining a maximum motion posture of the mobile robot; and determining the maximum tangential velocity of the mobile robot at the target point based on the radius of curvature and the maximum motion posture.

In some embodiments, the processor 1002 may invoke the program instruction stored in the storage media 1001, and may further be configured to perform the following steps: obtaining at least one sharp turning point in the navigation path; obtaining a maximum tangential velocity of the mobile robot on each sharp turning point; and controlling a tangential velocity of the mobile robot, so that when the mobile robot arrives at each sharp turning point, the tangential velocity of the mobile robot is less than or equal to the maximum tangential velocity corresponding to the sharp turning point.

In some embodiments, the processor 1002 may invoke the program instruction stored in the storage media 1001, and when obtaining the maximum tangential velocity of the mobile robot on each sharp turning point, may be configured to perform the following steps: obtaining a radius of curvature of each sharp turning point in the navigation path; obtaining a maximum motion posture of the mobile robot; and determining the maximum tangential velocity of the mobile robot on each sharp turning point based on the radius of curvature and the maximum motion posture.

In some embodiments, the processor 1002 may invoke the program instruction stored in the storage media 1001, and when obtaining the location of the mobile robot, may be configured to perform the following steps: obtaining a measured location output by a positioning sensor of the mobile robot; and modifying the measured location based on a system delay, to obtain the location of the mobile robot.

In this embodiment of the present application, the location of the mobile robot may be obtained; the target point that satisfies the preset location relationship with the location of the mobile robot may be determined in the navigation path; and the mobile robot may be controlled to move toward the target point in the navigation path. In this way, tracking control may be implemented on the navigation path of the mobile robot, the mobile robot moving in the navigation path may be prevented from departing from the navigation path, and accuracy of tracking control may be improved.

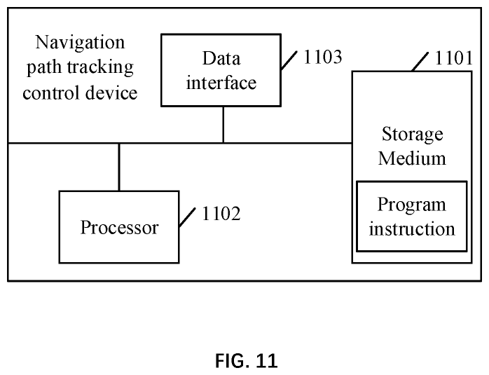

FIG. 11 is a schematic structural diagram of another navigation path tracking control device according to some embodiments of the present application.

In some embodiments, the navigation path tracking control device may include a storage media 1101, a processor 1102, and a data interface 1103.

The data interface 1103 may be configured to transfer data information between the navigation path tracking control device and a mobile robot.

The storage media 1101 may include a volatile memory. The storage media 1101 may also include a non-volatile memory. The storage media 1101 may further include a combination of the foregoing types of memories. The processor 1102 may be a central processing unit (CPU). The processor 1102 may further include a hardware chip. The hardware chip may be an application-specific integrated circuit (ASIC), a programmable logic device (PLD), or a combination thereof. The PLD may be a complex programmable logic device (CPLD), a field-programmable gate array (FPGA), or any combination thereof.

The storage media 1101 may be configured to store a program instruction. The processor 1102 may invoke the program instruction stored in the storage media 1001, and may be configured to perform the following steps: obtaining a maximum tangential velocity of the mobile robot on a point in a navigation path; and controlling a tangential velocity of the mobile robot, so that when the mobile robot arrives at the point, the tangential velocity of the mobile robot is less than or equal to the maximum tangential velocity.

In some embodiments, the processor 1102 may invoke the program instruction stored in the storage media 1101, and when obtaining the maximum tangential velocity of the mobile robot at the point in the navigation path, may be configured to perform the following steps: obtaining a radius of curvature of the point in the navigation path; obtaining a maximum motion posture of the mobile robot; and determining the maximum tangential velocity of the mobile robot at the point based on the radius of curvature and the maximum motion posture.

In some embodiments, the point may be a sharp turning point in the navigation path.

In some embodiments, the processor 1102 may invoke the program instruction stored in the storage media 1101, and when controlling the tangential velocity of the mobile robot, may be configured to perform the following steps: determining a distance between the mobile robot in a navigation path direction and the point in the navigation path; and if the distance is less than or equal to a preset distance threshold and the tangential velocity of the mobile robot is greater than or equal to the maximum tangential velocity, controlling the mobile robot to reduce the speed, so that when the mobile robot arrives at the point, the tangential velocity of the mobile robot is less than or equal to the maximum tangential velocity corresponding to the sharp turning point.

In some embodiments, the processor 1102 may invoke the program instruction stored in the storage media 1101, and when determining the distance between the mobile robot in the navigation path direction and the point in the navigation path, may be configured to perform the following step: determining the distance between the mobile robot in the navigation path direction and the point in the navigation path based on a location of the mobile robot and a location of the point.

In some embodiments, the processor 1102 may invoke the program instruction stored in the storage media 1101, and may further be configured to perform the following steps: obtaining a measured location output by a positioning sensor of the mobile robot; and modifying the measured location based on a system delay, to obtain the location of the mobile robot.

In this embodiment of the present application, the navigation path tracking control device may obtain the maximum tangential velocity of the mobile robot at the point in the navigation path, and control the tangential velocity of the mobile robot, so that when the mobile robot arrives at the point, the tangential velocity of the mobile robot is less than or equal to the maximum tangential velocity, and that the mobile robot moving in the navigation path may be prevented from departing from the navigation path.

Some embodiments of the present application may further provide a mobile robot, which may include: a body; a power system configured on the body and configured to supply power to the mobile robot for moving; and a processor configured to obtain a location of the mobile robot, determine, in a navigation path, a target point that satisfies a preset location relationship with the location of the mobile robot; and control the mobile robot to move toward the target point in the navigation path.

In some embodiments, the target point that satisfies the preset location relationship with the location of the mobile robot may be a target point closest to the location of the mobile robot.

In some embodiments, when controlling the mobile robot to move toward the target point in the navigation path, the processor may be configured to: determine a radial control error based on a distance between the target point and the location of the mobile robot; and control, based on the radial control error, the mobile robot to move toward the target point in a radial direction of the navigation path at the target point.

In some embodiments, when determining the radial control error based on the distance between the target point and the location of the mobile robot, the processor may be configured to: determine the distance between the target point and the location of the mobile robot as the radial control error.

In some embodiments, the processor may further be configured to: obtain a velocity of the mobile robot; and when controlling, based on the radial control error, the mobile robot to move toward the target point in the radial direction of the navigation path at the target point, the processor may be configured to: control, based on the radial control error and the velocity, the mobile robot to move toward the target point in the radial direction of the navigation path at the target point.

In some embodiments, the processor may be configured to: obtain a tangential velocity of the velocity in a tangential direction; and determine compensatory centripetal acceleration based on the tangential velocity and a radius of curvature corresponding to the target point; and when controlling, based on the radial control error and the velocity, the mobile robot to move toward the target point in the radial direction of the navigation path at the target point, the processor is specifically configured to: control, based on the radial control error and the compensatory centripetal acceleration, the mobile robot to move toward the target point in the radial direction of the navigation path at the target point.

In some embodiments, the processor may be configured to: obtain a radial velocity of the velocity in the radial direction; and when controlling, based on the radial control error and the velocity, the mobile robot to move toward the target point in the radial direction of the navigation path at the target point, the processor is specifically configured to: control, based on the radial control error, the compensatory centripetal acceleration, and the radial velocity, the mobile robot to move toward the target point in the radial direction of the navigation path at the target point.

In some embodiments, when determining, in the navigation path, the target point that satisfies the preset location relationship with the location of the mobile robot, the processor may be configured to: by using a reference point in the navigation path as a start point, determine, in the navigation path in a preset length range in a navigation path direction, the target point that satisfies the preset location relationship with the location of the mobile robot.

In some embodiments, the reference point may be a previous target point.

In some embodiments, the processor may further be configured to: obtain a maximum tangential velocity of the mobile robot at the target point; and control the tangential velocity of the mobile robot, so that when the mobile robot arrives at the target point, the tangential velocity of the mobile robot is less than or equal to the maximum tangential velocity.

In some embodiments, when obtaining the maximum tangential velocity of the mobile robot at the target point, the processor may be configured to: obtain the radius of curvature of the target point in the navigation path; obtain a maximum motion posture of the mobile robot; and determine the maximum tangential velocity of the mobile robot at the target point based on the radius of curvature and the maximum motion posture.

In some embodiments, the processor may further be configured to: obtain at least one sharp turning point in the navigation path; obtain a maximum tangential velocity of the mobile robot on each sharp turning point; and control a tangential velocity of the mobile robot, so that when the mobile robot arrives at each sharp turning point, the tangential velocity of the mobile robot is less than or equal to the maximum tangential velocity corresponding to the sharp turning point.

In some embodiments, when obtaining the maximum tangential velocity of the mobile robot on each sharp turning point, the processor may be configured to: obtain a radius of curvature of each sharp turning point in the navigation path; obtain a maximum motion posture of the mobile robot; and determine the maximum tangential velocity of the mobile robot on each sharp turning point based on the radius of curvature and the maximum motion posture.

In some embodiments, when obtaining the location of the mobile robot, the processor may be configured to: obtain a measured location output by a positioning sensor of the mobile robot; and modify the measured location based on a system delay, to obtain the location of the mobile robot.

In this embodiment of the present application, the location of the mobile robot may be obtained; the target point that satisfies the preset location relationship with the location of the mobile robot may be determined in the navigation path; and the mobile robot may be controlled to move toward the target point in the navigation path. In this way, accurate tracking control may be implemented on the navigation path of the mobile robot, and accuracy and robustness of tracking control may be improved.

Some embodiments of the present application may provide another mobile robot, which may include: a body; a power system configured on the body and configured to supply power to the mobile robot for moving; and a processor configured to perform the following steps: obtaining a maximum tangential velocity of the mobile robot on a point in a navigation path; and controlling a tangential velocity of the mobile robot, so that when the mobile robot arrives at the point, the tangential velocity of the mobile robot is less than or equal to the maximum tangential velocity.

In some embodiments, when obtaining the maximum tangential velocity of the mobile robot at the point in the navigation path, the processor may be configured to: obtain a radius of curvature of the point in the navigation path; obtain a maximum motion posture of the mobile robot; and determine the maximum tangential velocity of the mobile robot at the point based on the radius of curvature and the maximum motion posture.

In some embodiments, the point may be a sharp turning point in the navigation path.

In some embodiments, when controlling the tangential velocity of the mobile robot, the processor may be configured to: determine a distance between the mobile robot in a navigation path direction and the point in the navigation path; and if the distance is less than or equal to a preset distance threshold and the tangential velocity of the mobile robot is greater than or equal to the maximum tangential velocity, control the mobile robot to reduce the speed, so that when the mobile robot arrives at the point, the tangential velocity of the mobile robot is less than or equal to the maximum tangential velocity corresponding to the sharp turning point.

In some embodiments, when determining the distance between the mobile robot in the navigation path direction and the point in the navigation path, the processor may be configured to: determine the distance between the mobile robot in the navigation path direction and the point in the navigation path based on a location of the mobile robot and a location of the point.

In some embodiments, the processor may be further configured to: obtain a measured location output by a positioning sensor of the mobile robot; and modify the measured location based on a system delay, to obtain the location of the mobile robot.

In this embodiment of the present application, the navigation path tracking control device obtains the maximum tangential velocity of the mobile robot at the point in the navigation path, and controls the tangential velocity of the mobile robot, so that when the mobile robot arrives at the point, the tangential velocity of the mobile robot is less than or equal to the maximum tangential velocity, and that the mobile robot moving in the navigation path is prevented from departing from the navigation path.

Some embodiments of the present application may further provide a navigation path tracking control system, which may include a navigation path tracking control device and a mobile robot, where the navigation path tracking control device may be configured to: obtain a location of the mobile robot; determine, in a navigation path, a target point that satisfies a preset location relationship with the location of the mobile robot; and send a control instruction to the mobile robot, where the control instruction is used to control the mobile robot to move toward the target point in the navigation path; and the mobile robot may be configured to move toward the target point in the navigation path in response to the control instruction.

In some embodiments, the target point that satisfies the preset location relationship with the location of the mobile robot may be a target point closest to the location of the mobile robot.

In some embodiments, the navigation path tracking control device may be configured to: determine a radial control error based on a distance between the target point and the location of the mobile robot; and control, based on the radial control error, the mobile robot to move toward the target point in a radial direction of the navigation path at the target point.

In some embodiments, the navigation path tracking control device may be configured to determine the distance between the target point and the location of the mobile robot as the radial control error.

In some embodiments, the navigation path tracking control device may be further configured to: obtain a velocity of the mobile robot; and control, based on the radial control error and the velocity, the mobile robot to move toward the target point in the radial direction of the navigation path at the target point.

In some embodiments, the navigation path tracking control device may be further configured to: obtain a tangential velocity of the velocity in a tangential direction; determine compensatory centripetal acceleration based on the tangential velocity and a radius of curvature corresponding to the target point; and control, based on the radial control error and the compensatory centripetal acceleration, the mobile robot to move toward the target point in the radial direction of the navigation path at the target point.

In some embodiments, the navigation path tracking control device may be further configured to: obtain a radial velocity of the velocity in the radial direction; and control, based on the radial control error, the compensatory centripetal acceleration, and the radial velocity, the mobile robot to move toward the target point in the radial direction of the navigation path at the target point.

In some embodiments, the navigation path tracking control device may be configured to: by using a reference point in the navigation path as a start point, determine, in the navigation path in a preset length range in a navigation path direction, the target point that satisfies the preset location relationship with the location of the mobile robot.

In some embodiments, the reference point may be a previous target point.

In some embodiments, the navigation path tracking control device may be further configured to: obtain a maximum tangential velocity of the mobile robot at the target point; and control the tangential velocity of the mobile robot, so that when the mobile robot arrives at the target point, the tangential velocity of the mobile robot is less than or equal to the maximum tangential velocity.

In some embodiments, the navigation path tracking control device may be configured to: obtain the radius of curvature of the target point in the navigation path; obtain a maximum motion posture of the mobile robot; and determine the maximum tangential velocity of the mobile robot at the target point based on the radius of curvature and the maximum motion posture.

In some embodiments, the navigation path tracking control device may be further configured to: obtain at least one sharp turning point in the navigation path; obtain a maximum tangential velocity of the mobile robot on each sharp turning point; and control a tangential velocity of the mobile robot, so that when the mobile robot arrives at each sharp turning point, the tangential velocity of the mobile robot is less than or equal to the maximum tangential velocity corresponding to the sharp turning point.

In some embodiments, the navigation path tracking control device may be configured to: obtain a radius of curvature of each sharp turning point in the navigation path; obtain a maximum motion posture of the mobile robot; and determine the maximum tangential velocity of the mobile robot on each sharp turning point based on the radius of curvature and the maximum motion posture.

In some embodiments, the navigation path tracking control device may be configured to: obtain a measured location output by a positioning sensor of the mobile robot; and modify the measured location based on a system delay, to obtain the location of the mobile robot.

Some embodiments of the present application may further provide another navigation path tracking control system, which may include a navigation path tracking control device and a mobile robot, where the navigation path tracking control device may be configured to: obtain a maximum tangential velocity of the mobile robot on a point in a navigation path; and send a mobility control instruction to the mobile robot, where the mobility control instruction is used to control a tangential velocity of the mobile robot, so that when the mobile robot arrives at the point, the tangential velocity of the mobile robot is less than or equal to the maximum tangential velocity; and the mobile robot may be configured to move in the navigation path in response to the mobility control instruction.

In some embodiments, the navigation path tracking control device may be configured to: obtain a radius of curvature of the point in the navigation path; obtain a maximum motion posture of the mobile robot; and determine the maximum tangential velocity of the mobile robot at the point based on the radius of curvature and the maximum motion posture.

In some embodiments, the point may be a sharp turning point in the navigation path.

In some embodiments, the navigation path tracking control device may be configured to: determine a distance between the mobile robot in a navigation path direction and the point in the navigation path; and if the distance is less than or equal to a preset distance threshold and the tangential velocity of the mobile robot is greater than or equal to the maximum tangential velocity, control the mobile robot to reduce the speed, so that when the mobile robot arrives at the point, the tangential velocity of the mobile robot is less than or equal to the maximum tangential velocity corresponding to the sharp turning point.

In some embodiments, the navigation path tracking control device may be configured to determine the distance between the mobile robot in the navigation path direction and the point in the navigation path based on a location of the mobile robot and a location of the point.

In some embodiments, the navigation path tracking control device may be further configured to: obtain a measured location output by a positioning sensor of the mobile robot; and modify the measured location based on a system delay, to obtain the location of the mobile robot.

Some embodiments of the present application may further provide a computer-readable storage medium, where the computer-readable storage medium stores a computer program, and when the computer program is executed by a processor, the navigation path tracking control method for a mobile robot as described in the embodiment corresponding to FIG. 1, FIG. 4, FIG. 6, or FIG. 8 of the present application is implemented, or the navigation path tracking control device in the embodiment corresponding to FIG. 9 or FIG. 10 of the present application may be implemented. Details are not described again herein.

The computer-readable storage medium may be an internal storage unit of the device in any one of the foregoing embodiments, for example, a hard disk or a memory of the device. Alternatively, the computer-readable storage medium may be an external storage device of the device, for example, a removable hard disk configured on the device, a smart media card (SMC), a secure digital (SD) card, or a flash memory card (Flash Card). In some embodiments, the computer-readable storage medium may further include an internal storage unit of the device and an external storage device. The computer-readable storage medium is configured to store the computer program and another program and data required by the terminal. The computer-readable storage medium may be further configured to temporarily store data that is already output or will be output.

What is disclosed above is merely some embodiments of the present application, and is certainly not intended to limit the protection scope of the present application. Therefore, equivalent variations made in accordance with the claims of the present application shall fall within the scope of the present application.

What is claimed is:

1. A device for navigation path tracking control of a mobile robot, comprising:
one or more storage media, storing a set of instructions for tracking and controlling a navigation path; and
one or more processors in communication with the one or more storage media, wherein during operation the one or more processors execute the set of instructions to:
obtain a location of a mobile robot;
determine, in a navigation path, a target point that satisfies a preset location relationship with the location of the mobile robot; and
control the mobile robot to move toward the target point in the navigation path.

2. The device according to claim 1, wherein the target point is a target point closest to the location of the mobile robot.

3. The device according to claim 1, wherein to control the mobile robot to move toward the target point in the navigation path, the one or more processors execute the set of instructions to:
determine a radial control error based on a distance between the target point and the location of the mobile robot, and
control, based on the radial control error, the mobile robot to move toward the target point in a radial direction of the navigation path at the target point.

4. The device according to claim 3, wherein to determine the radial control error, the one or more processors execute the set of instructions to:
determine the distance between the target point and the location of the mobile robot as the radial control error.

5. The device according to claim 3, wherein during operation the one or more processors further execute the set of instructions to:
obtain a velocity of the mobile robot,
wherein to control the mobile robot to move toward the target point in a radial direction of the navigation path at the target point, the one or more processors execute the set of instructions to:
control, based on the radial control error and the velocity, the mobile robot to move toward the target point in the radial direction of the navigation path at the target point.

6. The device according to claim 5, wherein during operation the one or more processors further execute the set of instructions to:
obtain a tangential velocity component from the velocity, wherein the tangential velocity is in a tangential direction of the navigation path at the target point; and
determine a compensatory centripetal acceleration based on the tangential velocity and a radius of curvature of the navigation path at the target point,
wherein to control the mobile robot to move toward the target point in the radial direction of the navigation path at the target point, the one or more processors execute the set of instructions to:
control, based on the radial control error and the compensatory centripetal acceleration, the mobile robot to move toward the target point in the radial direction of the navigation path at the target point.

7. The device according to claim 6, wherein during operation the one or more processors further execute the set of instructions to:
obtain a radial velocity component from the velocity, wherein the radial velocity is in the radial direction of the navigation path at the target point,
wherein to control the mobile robot to move toward the target point in the radial direction of the navigation path at the target point, the one or more processors execute the set of instructions to:
controlling, based on the radial control error, the compensatory centripetal acceleration, and the radial velocity, the mobile robot to move toward the target point in the radial direction of the navigation path at the target point.

8. The device according to claim 1, wherein to determine the target point, the one or more processors execute the set of instructions to:
determine, by using a reference point in the navigation path as a start point, the target point in the navigation path in a preset length range along the navigation path.

9. The device according to claim 8, wherein the reference point is a previous target point.

10. The device according to claim 1, wherein during operation the one or more processors further execute the set of instructions to:
obtain a maximum tangential velocity of the mobile robot at the target point; and
controlling a tangential velocity of the mobile robot, so that when the mobile robot arrives at the target point, the tangential velocity of the mobile robot is less than the maximum tangential velocity, wherein the tangential velocity is in a tangential direction of the navigation path at the target point.

11. The device according to claim 10, wherein to obtain the maximum tangential velocity of the mobile robot at the target point, the one or more processors execute the set of instructions to:
obtain a radius of curvature of the navigation path at the target point,
obtain a maximum motion posture of the mobile robot, and
determine the maximum tangential velocity of the mobile robot at the target point based on the radius of curvature and the maximum motion posture.

12. The device according to claim 1, wherein during operation the one or more processors further execute the set of instructions to:
obtain at least one sharp turning point in the navigation path;
obtain a maximum tangential velocity of the mobile robot at each sharp turning point; and
control a tangential velocity of the mobile robot, so that when the mobile robot arrives at each sharp turning point, the tangential velocity of the mobile robot is less than the maximum tangential velocity corresponding to the sharp turning point.

13. The device according to claim 12, wherein to obtain the maximum tangential velocity of the mobile robot at each sharp turning point, the one or more processors execute the set of instructions to:
obtain a radius of curvature of the navigation path at each sharp turning point,
obtain a maximum motion posture of the mobile robot, and
determine the maximum tangential velocity of the mobile robot at each sharp turning point based on the radius of curvature and the maximum motion posture.

14. The device according to claim 1, wherein to obtain the location of the mobile robot, the one or more processors execute the set of instructions to:
obtain a measured location output by a positioning sensor of the mobile robot, and
modify the measured location based on a system delay, to obtain the location of the mobile robot.

15. A method for navigation path tracking control, comprising:
obtaining a location of a mobile robot;
determining, in a navigation path, a target point that satisfies a preset location relationship with the location of the mobile robot; and
controlling the mobile robot to move toward the target point in the navigation path.

16. The method according to claim 15, wherein the target point is a target point closest to the location of the mobile robot.

17. The method according to claim 15, wherein the controlling of the mobile robot to move toward the target point in the navigation path includes:
determining a radial control error based on a distance between the target point and the location of the mobile robot; and
controlling, based on the radial control error, the mobile robot to move toward the target point in a radial direction of the navigation path at the target point.

18. The method according to claim 17, wherein the determining of the radial control error includes:
determining the distance between the target point and the location of the mobile robot as the radial control error.

19. The method according to claim 15, further comprising:
obtaining a maximum tangential velocity of the mobile robot at the target point; and
controlling the tangential velocity of the mobile robot, so that when the mobile robot arrives at the target point, the tangential velocity of the mobile robot is less than the maximum tangential velocity.

20. The method according to claim 15, further comprising:
obtaining at least one sharp turning point in the navigation path;
obtaining a maximum tangential velocity of the mobile robot at each sharp turning point; and
controlling a tangential velocity of the mobile robot, so that when the mobile robot arrives at each sharp turning point, the tangential velocity of the mobile robot is less than the maximum tangential velocity corresponding to the sharp turning point.
